(19) United States
(12) Patent Application Publication
(10) Pub. No.: US 2008/0296986 A1
(43) Pub. Date: Dec. 4, 2008

(54) BUSHING AND GENERATOR

(76) Inventors: Tatsuro KOZAKI, Mito (JP); Hiroyuki SATO, Hitachi (JP); Kazuhiko TAKAHASHI, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/131,411

(22) Filed: Jun. 2, 2008

(30) Foreign Application Priority Data
Jun. 4, 2007 (JP) 2007-148119

(51) Int. Cl. H01B 17/26; H02K 9/08; H02K 5/16

(52) U.S. Cl. 310/58; 174/15.3; 310/66

(57) ABSTRACT

In a bushing which has a terminal with a bend for connecting a conduit tube and a lead tube, the effect to cool the inner corner of the bend is enhanced. The bushing includes a conductive conduit tube, a conductive lead tube, and a terminal. The terminal has a bend and connects the conduit tube and the lead tube. Electric current and cooling gas flows in these tubes. A cooling means is provided for forced cooling of the inner corner of the bend of the terminal. One example of the cooling means is a guide vane which makes cooling gas flowing in the bushing come closer to the inner corner of the bend. A larger current can flow even when the bushing has the same size as a conventional one.

### CLAIM OF PRIORITY

The present application claims priority from Japanese patent application JP 2007-148119 filed on Jun. 4, 2007, the content of which is hereby incorporated by reference into this application.

1. Field of the Invention

The present invention relates to a bushing, particularly a bushing which allows electric current and cooling gas to flow through a containment vessel to a generator main unit placed in the containment vessel, and a generator with this bushing. The bushing according to the present invention can be applied to many types of electric equipment for large currents, such as generators used in electric power stations and transformers or condensers used in transforming stations.

2. Background of the Invention

In an electric power station, when a generator main unit is placed in an atmosphere of cooling gas such as hydrogen gas, which is confined by a containment vessel, electric current path must penetrate the wall of the containment vessel in order to lead the electric power generated by the generator to an off-site power system. At the penetration part of the electric current path, an insulated bushing is used to prevent the power line current from leaking through the containment vessel.

The bushing should be easy to assemble, easy to service, and be able to absorb expansion or contraction with temperature change of peripheral devices around the bushing. Also the bushing and the devices around it should be compact. For this reason, the structure around the bushing is complicated and the total of electric contact resistances between components in the peripheral devices is large; for example, if currents of tens of kiloamperes flow, joule heat of tens of kilowatts is generated.

In order to suppress the temperature increase of the devices around the bushing and maintain the soundness of the bushing and the devices, the bushing is designed to flow the cooling gas such as hydrogen gas through it and cool itself down.

However, a satisfactory cooling effect cannot be achieved simply by flowing the cooling gas through the bushing. One approach to this problem is to mount many radiating fins on a terminal, which connects leads to link the bushing and other electric equipment and where temperature tends to rise more in the bushing and the devices (for example, see JP-A HEI 10-283860 (abstract)).

In a bushing including a conductive conduit tube, a conductive lead tube and a terminal for connecting the conduit tube and the lead tube, when the terminal has a bend, the inner corner of the bend tends to be higher in temperature than other parts. If the temperature of the inner corner of the bend is kept low, it enables a larger current to flow without increasing the sizes of the bushing, the devices around it, and the generator itself.

In JP-A HEI 10-283860, no means to improve the cooling effect at the bend is described for a bushing which has a terminal with a bend.

An object of the present invention is to provide a bushing which is, for a terminal with a bend, designed to improve the effect to cool the inner corner of the bend, and to provide a generator including the same.

### SUMMARY OF THE INVENTION

According to one aspect of the present invention, a bushing includes a conductive conduit tube, a conductive lead tube, and a terminal for connecting the conduit tube and the lead tube. In this bushing, the terminal has a bend and electric current flows in the conduit tube, the terminal, and the lead tube. Cooling gas flows in the conduit tube, the terminal, and the lead tube, and a cooling means is provided for forced cooling of the inner corner of the bend of the terminal.

According to another aspect of the invention, a generator includes a generator main unit, a containment vessel to place the generator main unit in a cooling gas atmosphere, a bushing which penetrates the containment vessel and enables electric current to flow through the containment vessel, and a blower and a gas cooler which feed cooling gas into the containment vessel and the bushing. The bushing includes a conduit tube, a lead tube to be connected with the generator main unit, and a terminal which connects the conduit tube and the lead tube. The terminal has a bend and a cooling means is provided for forced cooling of the inner corner of the bend of the terminal.

As a cooling means for forced cooling of the inner corner of the terminal, it is preferable that a guide be provided in the terminal to concentrate the cooling gas flowing in the terminal on the inner corner of the bend. It is also preferable that a radiating fin be provided on an inner or outer surface of the inner corner of the bend of the terminal. It is also preferable that a mechanism be provided to make the cooling gas hit outside of the inner corner of the terminal. It is possible to use a combination of these means.

According to the present invention, a larger current can flow through the bushing than that in conventional cooling structures, even if the bushing size is unchanged. This means that a larger current can flow without increasing the sizes of the bushing, devices around the bushing, and generator itself.

### BRIEF DESCRIPTION OF THE DRAWINGS

FIG. 1 shows a cooling gas flow velocity distribution and a temperature distribution, in which a guide vane is attached in the generator's inside terminal;

FIG. 2 shows a structure of the inside terminal with a guide vane attached in it by casting etc.;

FIG. 3 shows a structure of the inside terminal with a guide vane attached in it by using a vane holder;

FIG. 4 shows a structure of the inside terminal with a guide vane attached in it by using an L-shaped vane holder;

FIG. 5 shows a structure of the inside terminal with a guide vane attached in it by using a flat-shaped vane holder;

FIG. 6 shows a structure of the inside terminal with a guide vane and an auxiliary guide vane attached in it by using a flat-shaped vane holder;

FIG. 7 shows a structure of the inside terminal with a radiating fin attached in it;

FIG. 8 shows a structure how cooling gas is led from the blower to the inner corner of the inside terminal through a blower tube;

FIG. 9 shows a structure where a cover is attached to the bushing;

FIG. 10 shows a structure how discharged cooling gas from the bushing is led to the outer surface of the inner corner of the inside terminal;

FIG. 11 shows a structure of the inside terminal with a radiating fin attached outside of it;

FIG. 12 shows a structure of the bushing and devices around it in the comparative example 1;

FIG. 13 shows a current distribution in the inside terminal in the comparative example 1;

FIG. 14 shows a cooling gas flow velocity distribution in the inside terminal in the comparative example 1;

FIG. 15 shows a temperature distribution in the inside terminal in the comparative example 1;

FIG. 16 is an assembly drawing of the inside terminal in the comparative example 1;

FIG. 17 is an assembly drawing of the inside terminal (2-fraction structure) in the comparative example 2; and

FIG. 18 is an assembly drawing of the inside terminal (3-fraction structure) in the comparative example 3.

### DETAILED DESCRIPTION OF THE PREFERRED EMBODIMENTS

Some comparative examples which were examined in the process of making the present invention will be explained before describing the preferred embodiments of the present invention below.

### COMPARATIVE EXAMPLE 1

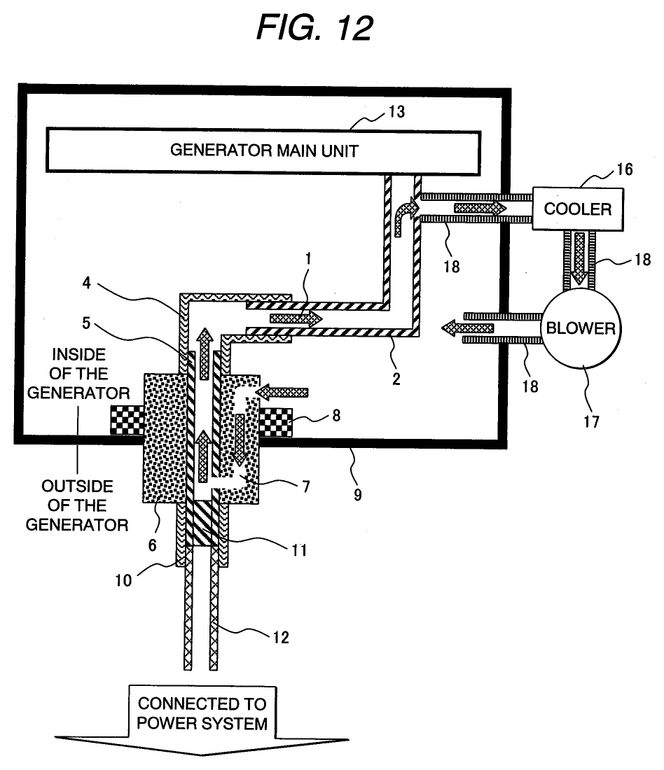

FIG. 12 shows a structure of a general bushing for large currents and devices around it. For electric current to flow through a containment vessel 9 housing a generator main unit 13, the bushing includes a conduit tube 5 through which current flows, an inside lead tube 2 which leads electric power from the generator main unit 13 or a motor into the conduit tube 5, an inside terminal 4 which connects the conduit tube 5 and the inside lead tube 2 inside the containment vessel 9, an outside lead tube 12 which feeds electric power to a station load or power system outside the containment vessel 9, and an outside terminal 10 which connects the conduit tube 5 and the outside lead tube 12 outside the containment vessel 9. It also includes an insulation member 6 and an insulation member holder 8 which fix and isolate the conduit tube 5 in the containment vessel 9.

In order to remove joule heat generated in the conduit tube 5 etc., a cooling mechanism for the bushing is so structured that cooling gas 1, such as hydrogen gas, cooled by a cooler 16 is circulated through a blower duct 18 made of insulation material, a ventilation hole 7 in the insulation member 6, the conduit tube 5, the inside terminal 4 and the inside lead tube 2 with a blower 17. A plug 11 is provided at the bottom of the conduit tube 5 to prevent the cooling gas 1 from flowing out of the containment vessel 9. The inside terminal 4 is bent for convenience in layout, covered by an insulation member for thermally insulation.

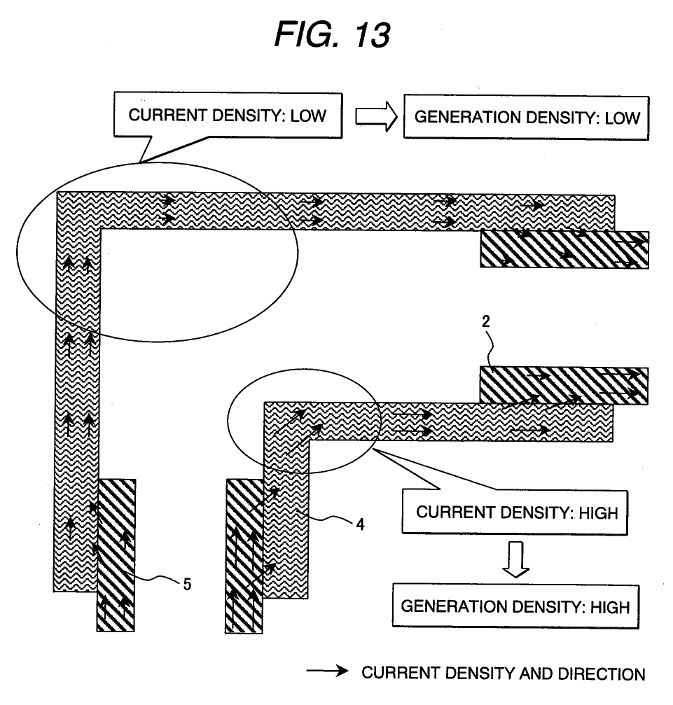

FIG. 13 shows a current distribution in the vertical section of the inside terminal 4 which electromagnetic field analysis revealed. As shown in the current distribution (instantaneous values) in FIG. 13, the current is found to concentrate on the periphery of the inner corner of the inside terminal 4 where it is bent. This is because current has a tendency to concentrate in a shorter route and, in the case of alternating current, concentrate on the periphery of the route (conductor) due to a conductor skin effect. Furthermore, since joule heat generation density is in proportion to the square of current density, joule heat concentrates on the periphery of the inner corner of the inside terminal 4 as well as in the case of current.

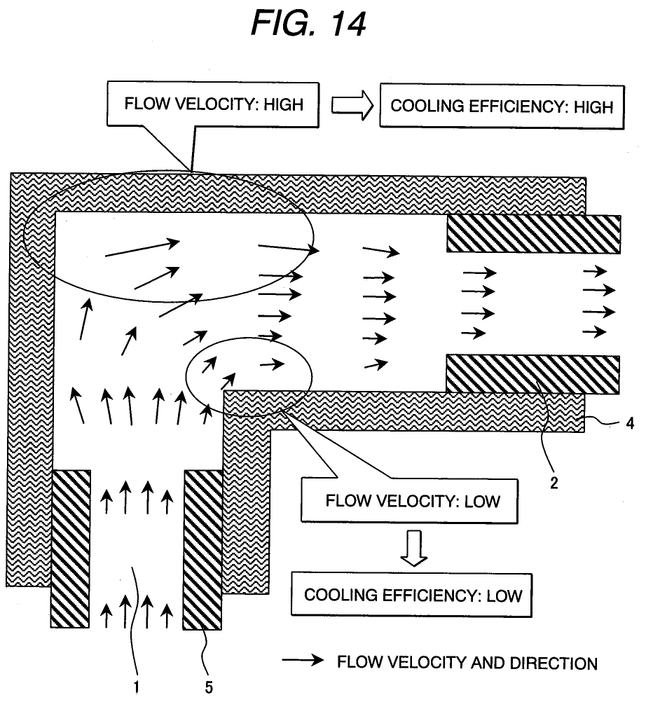

FIG. 14 shows a flow velocity distribution of the cooling gas 1 in the vertical section of the inside terminal 4 which thermal hydraulics analysis has revealed. As shown in FIG. 14, the cooling gas 1 is found to flow through the bent terminal while concentrating on the outer corner side in the latter half of the bend, namely on the downstream side close to the bend. The reason is that the direction of the gas flow cannot change immediately at the bend because of the gas's inertia. On the other hand, the coefficient of heat transfer between the cooling gas 1 and the wall of the terminal 4 is almost proportional to the flow velocity of the cooling gas 1. Therefore, the cooling efficiency is higher at the outer corner side than at the inner corner side.

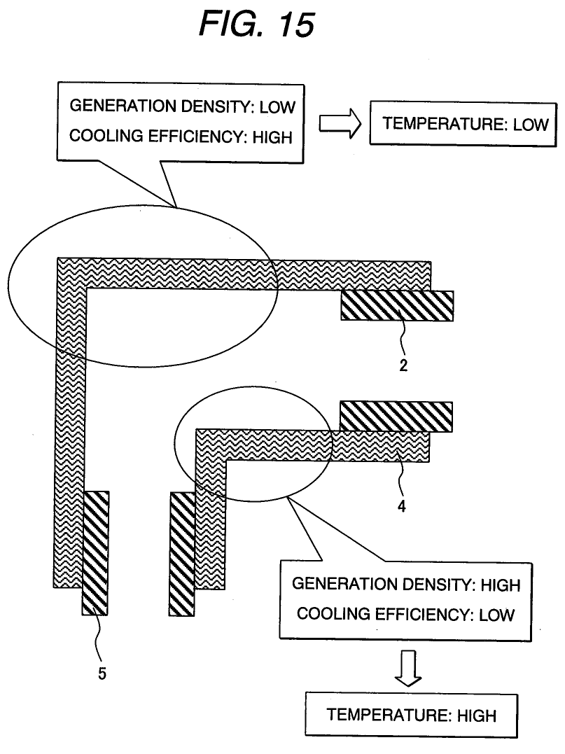

FIG. 15 shows a temperature distribution in the vertical section of the inside terminal 4 which thermal hydraulics analysis has revealed. As shown in FIG. 15, it is found that, in the outer corner (periphery side) of the bend of the inside terminal 4, less Joule heat is generated, cooling efficiency is high and thus the temperatures are low, while, in its inner corner, more heat is generated, cooling efficiency is low and therefore the temperatures are high. The maximum temperature is a constrained condition in bushing design.

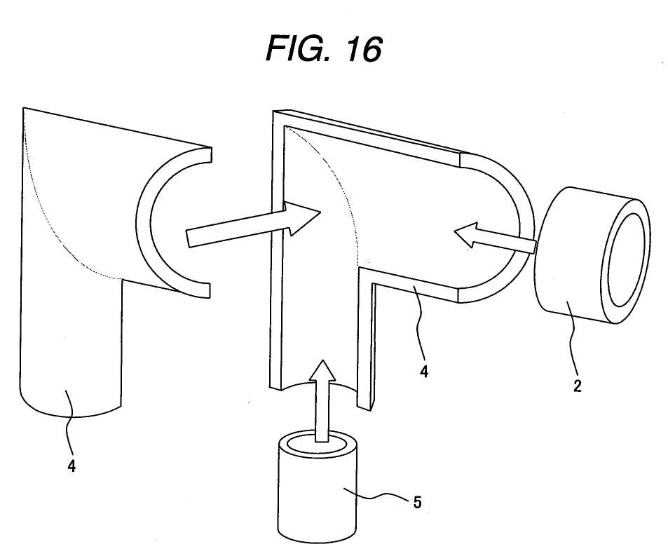

FIG. 16 is an assembly drawing of the inside terminal 4 of the comparative example 1. In the inside terminal 4, electric contact resistance needs to be decreased between the inside terminal 4 and the conduit tube 5 or the inside lead tube 2 in order to reduce joule heat generation and prevent temperature increase at the areas where the inside terminal 4 contacts them. For this reason, in the comparative example 1, the inside terminal 4 has a split structure, namely it consists of two parts as shown in FIG. 16, and these two parts are joined by fastening with bolts or the like so that the parts come into close contact with each other with increased pressure between them.

### COMPARATIVE EXAMPLE 2

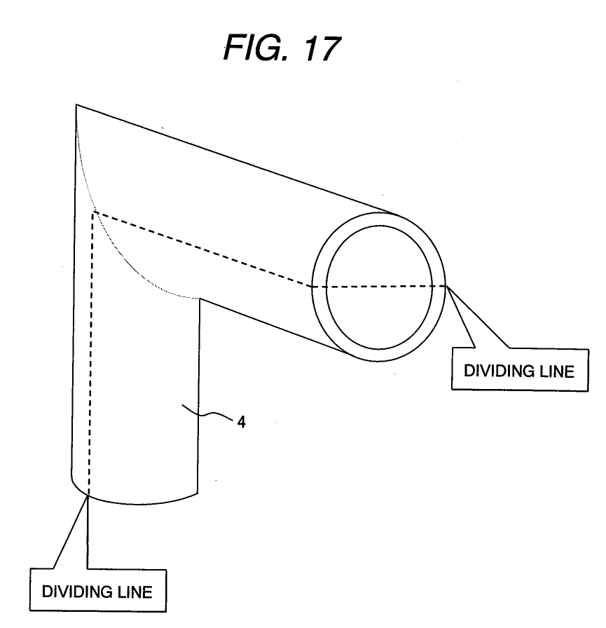

FIG. 17 shows another example of an inside terminal. This inside terminal can be divided into two fractions along the broken line.

### COMPARATIVE EXAMPLE 3

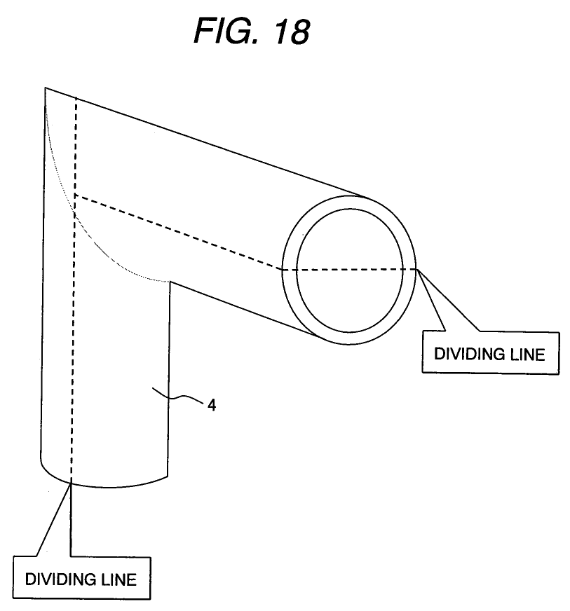

FIG. 18 also shows another example of an inside terminal. This inside terminal can be divided into three fractions along the broken line.

### First Embodiment

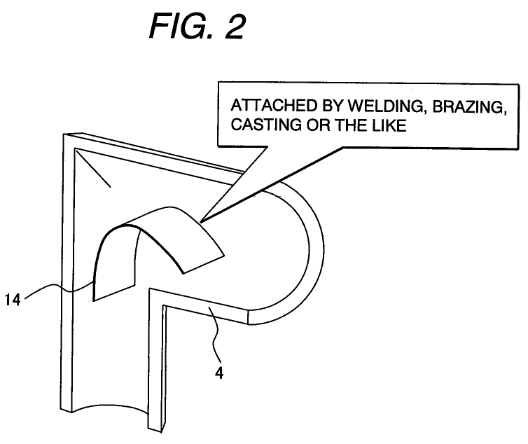

FIG. 2 shows a structure of an inside terminal 4 with a guide vane 14 in it. The guide vane 14 is installed in the inside terminal 4 which has the same structure as in the comparative example 1 except for the guide vane 14. In this embodiment, the guide vane 14 can be attached by welding, alloy brazing, casting or the like since the inside terminal 4 has a split structure.

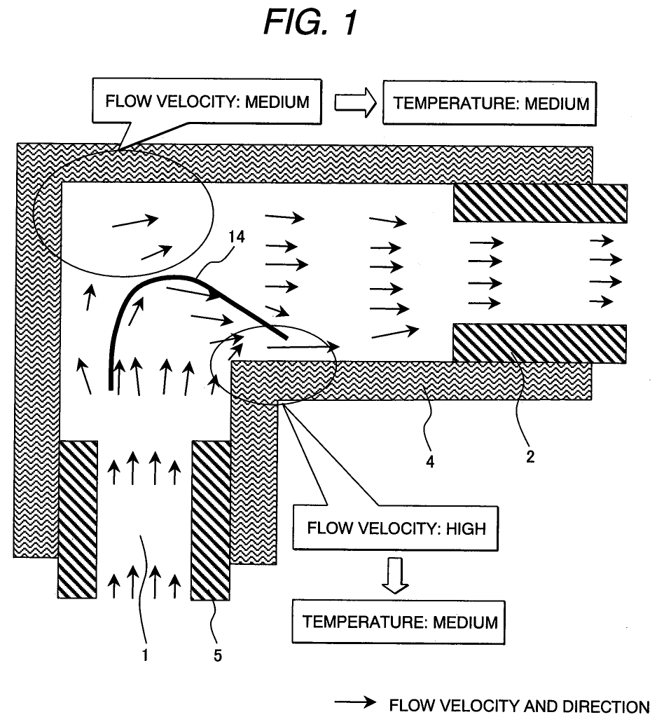

FIG. 1 shows a cooling gas flow velocity distribution in the vertical section of the inside terminal 4 with the guide vane 14 installed in it, which thermal hydraulics analysis has revealed. The guide vane 14 causes the inflowing cooling gas 1 from the conduit tube 5 to concentrate around the inner corner of the inside terminal 4 and flow at higher velocity. Consequently, the heat generated at the inner corner of the inside terminal 4 is efficiently removed and the temperature of the inner corner area is decreased. As the temperature decreases, the terminal's electric resistance becomes smaller and heat generation is reduced, resulting in further lowering of the temperature.

### Second Embodiment

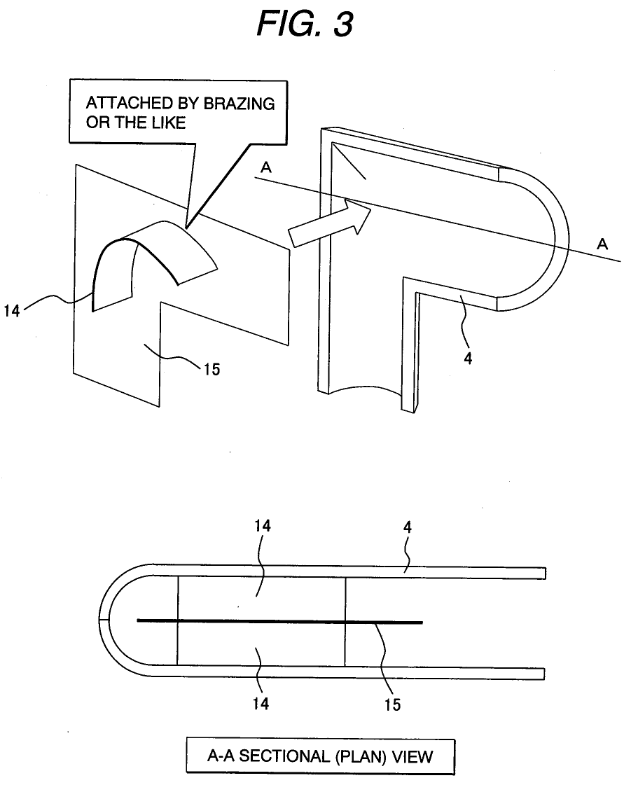

FIG. 3 shows a method of installing the guide vane 14. In this embodiment, the guide vane 14 is attached to a guide vane holder 15 in addition to the same terminal 4 as in the comparative example 1. The guide vane 14 and the guide vane holder 15 are sandwiched and fixed between the constituent parts of the inside terminal 4. Consequently, the same effect can be achieved as in the first embodiment.

### Third Embodiment

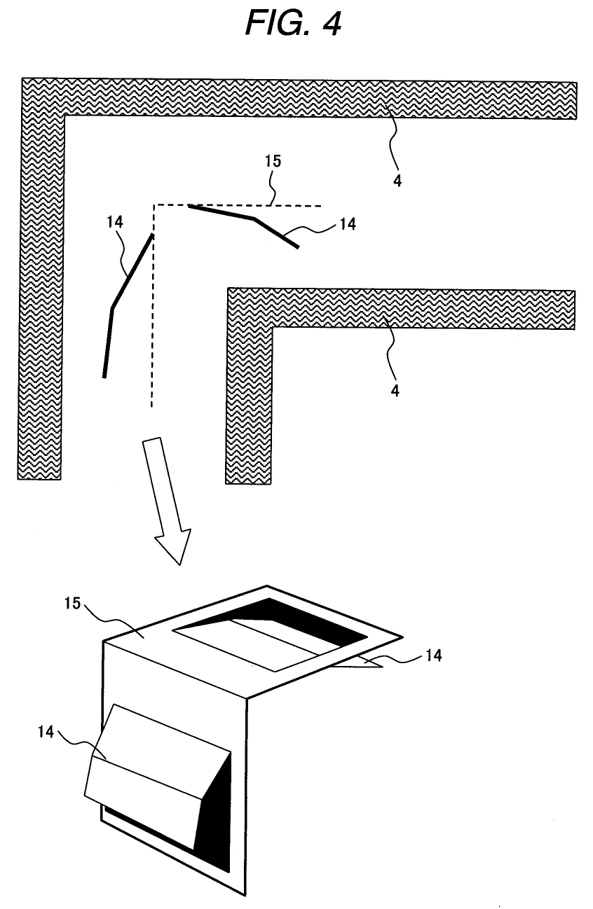

FIG. 4 shows another structure of installing the guide vane 14. The guide vane 14 is formed in an L-shaped guide vane holder 15 by cutting and bending a plate for the holder 15 in addition to the same terminal 4 as in the comparative example 2. The guide vane 14 and the guide vane holder 15 are sandwiched and fixed between the constituent parts of the inside terminal 4. Consequently, the same effect can be achieved as in the first and second embodiments.

### Fourth Embodiment

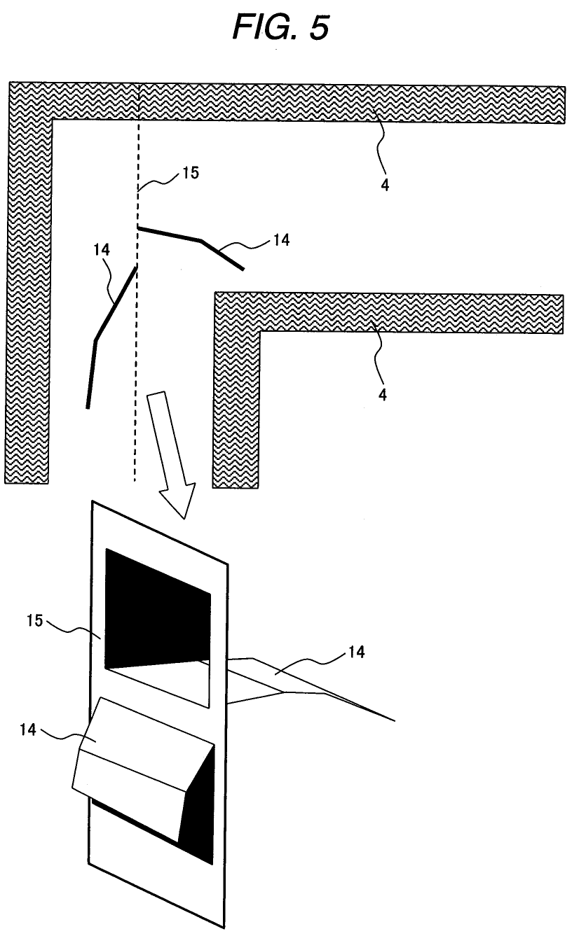

FIG. 5 also shows another structure of installing the guide vane 14. In this embodiment, the guide vane 14 is formed in a flat-shaped guide vane holder 15 by cutting and bending a plate for the holder 15 in addition to the same terminal 4 as in the comparative example 3. The guide vane 14 and the guide vane holder 15 are sandwiched and fixed between the constituent parts of the inside terminal 4. Consequently, the same effect can be achieved as in the first to third embodiments.

### Fifth Embodiment

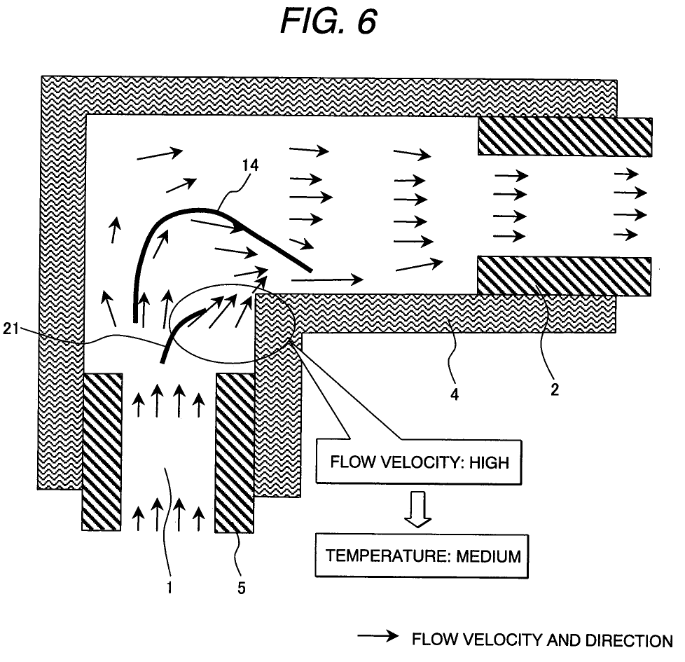

FIG. 6 shows a structure of installing an auxiliary guide vane 21 in addition to the guide vane 14. In the structures in the first to fourth embodiments where one guide vane 14 is attached, it is impossible for the cooling gas 1 to hit both the upstream side and downstream side of the inner corner of the inside terminal 4. As a solution to this, in this embodiment, an auxiliary guide vane 21 is installed nearer to the inner corner than the guide vane 14 as shown in FIG. 6 so that the cooling gas 1 hits the upstream side of the inner corner of the inside terminal 4. Consequently the temperatures are decreased more than in the first to fourth embodiments.

### Sixth Embodiment

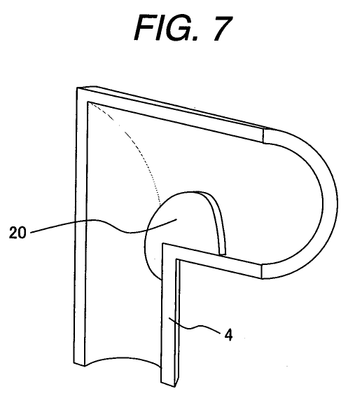

FIG. 7 shows a structure of installing a radiating fin 20. In the first to fifth embodiments, the cooling gas 1 hits the inner surface of the inner corner of the inside terminal 4. Mounting one or more radiating fins 20 on the inner corner of the inside terminal 4 as shown in FIG. 7 makes heat transfer area wider and therefore enables further decrease of the temperatures of the inner corner and its neighborhood.

### Seventh Embodiment

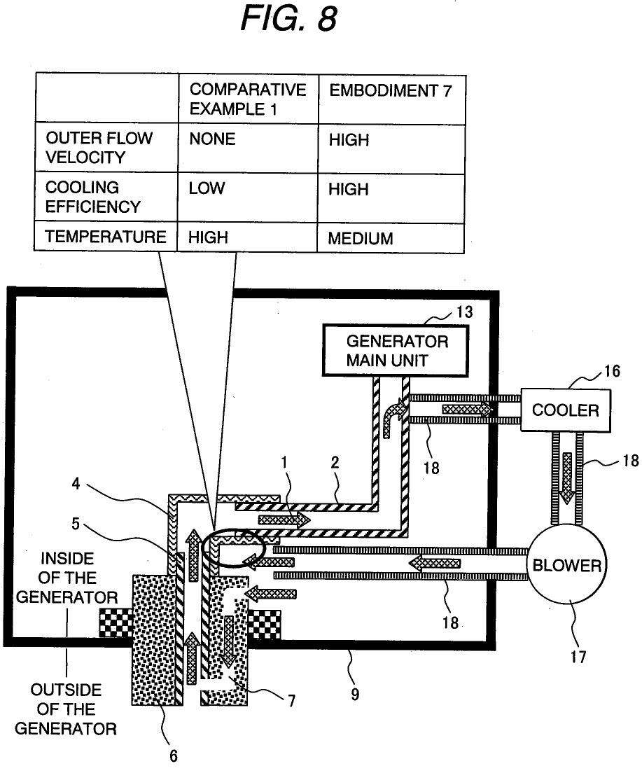

FIG. 8 shows a structure of the bushing and devices around it in the seventh embodiment. The present embodiment's structure has a similar cooling gas-circulating system to that of the comparative example 1. Namely, the circulating system comprises the blower duct 18, the ventilation hole 7, the conduit tube 5, the inside terminal 4, the inside lead tube 2 and the blower 17. A different technical point is that the downstream side of the blower duct 18 from the blower 17 is extended up to the immediate vicinity of the periphery of the inner corner of the inside terminal 4. Thereby the cooling gas 1 to be sent from the blower 17 to the bushing etc. is led to the inside terminal 4 through the circulating system, and the cooling gas 1 issued from an outlet of the blower duct 18 hits the outer surface of the inner corner of the inside terminal 4. Consequently the corner is cooled and the temperature increase is reduced.

### Eighth Embodiment

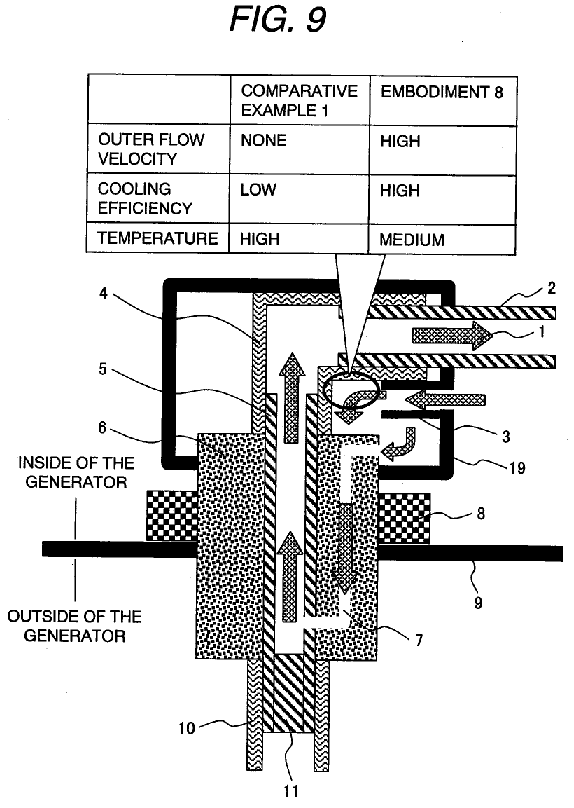

FIG. 9 shows a structure of the bushing and the devices around it in the eighth embodiment. Also the present embodiment's structure has a similar cooling gas-circulating system to that of the comparative example 1. A different technical point is as follows. An inside terminal cover 19 made of insulating material is attached so that it covers the inside terminal 4. The inside terminal cover 19 has a duct 3. An outlet of the duct 3 is positioned in the vicinity of the periphery of the inner corner of the inside terminal 4. Therefore, the cooling gas 1, which is sent from the blower 17 into the containment vessel 9, passes through the duct 3 of the inside terminal cover 19 to flow into the bushing. In this process, the cooling gas 1 hits the outer surface of the inner corner of the inside terminal 4 where much heat is generated. Consequently the corner is cooled and the temperature increase is reduced.

### Ninth Embodiment

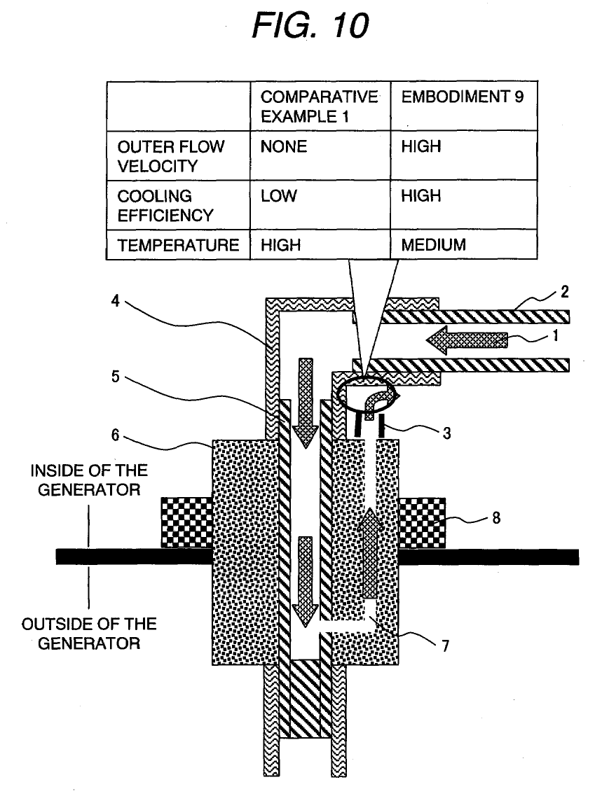

FIG. 10 shows another example of a structure of the bushing and the devices around it in the ninth embodiment. In this embodiment, the flow direction of the cooling gas 1 is reverse to that in the comparative examples 1 to 3 and the first to eighth embodiments. A duct 3 is attached to an outlet of the ventilation hole 7 so as to be directed to the periphery of the inner corner of the inside terminal 4. After the cooling gas 1 flows through the inside lead tube 2, the inside terminal 4 and the conduit tube 12, it flows out through the ventilation hole 7 in the insulation member 6 and is issued through the duct 3 so as to hit the outer surface of the inner corner of the inside terminal 4. Consequently the corner is cooled and the temperature increase is reduced.

### Tenth Embodiment

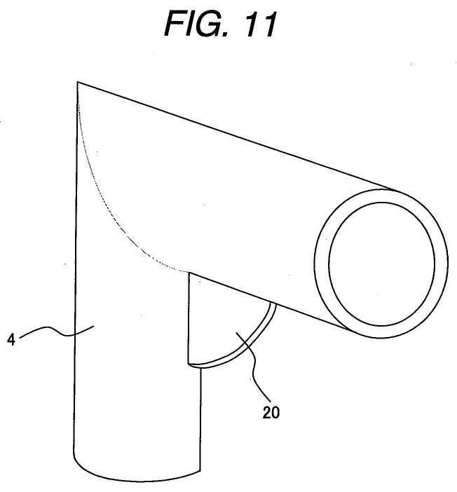

FIG. 11 shows a structure of attaching a radiating fin 20. In the seventh to ninth embodiments, the cooling gas 1 hits the outer surface of the inner corner of the inside terminal 4. Attaching one or more radiating fins 20 on the inner corner of the inside terminal 4 as shown in FIG. 11 makes heat transfer area wider and therefore enables further decrease of the temperatures of the inner corner and its neighborhood.

What is claimed is:

1. A bushing comprising:
a conductive conduit tube;
a conductive lead tube; and
a tube type terminal which connects the conduit tube and the lead tube;
wherein:
the terminal has a bend;
electric current flows through the conduit tube, the terminal, and the lead tube;
cooling gas flows through the conduit tube, the terminal, and the lead tube; and
a cooling means for forced cooling of an inner corner of the bend of the terminal is provided.

2. The bushing according to claim 1, wherein a guide is provided as the cooling means in the terminal to concentrate the cooling gas flowing through the terminal onto the inner corner of the bend.

3. The bushing according to claim 2, wherein the guide is a guide vane which directs the cooling gas flowing through the terminal come closer to the inner corner.

4. The bushing according to claim 3, wherein the guide vanes are provided on both upstream and downstream sides of the bend in a cooling gas flow direction and the upstream guide vane makes the cooling gas hit the upstream side of the inner corner and the downstream guide vane makes the cooling gas hit the downstream side of the inner corner.

5. The bushing according to claim 1, wherein a radiating fin is provided on an inner surface of the inner corner of the bend of the terminal as the cooling means.

6. The bushing according to claim 1, wherein the gas cooling means is configured to pass the cooling gas through a route of the conduit tube, the terminal and the lead tube, issue the cooling gas outside the route to forcedly cool the inner corner of the bend of the terminal with the cooling gas from outside.

7. The bushing according to claim 6, wherein the gas cooling means makes the cooling gas hit an outer surface of the inner corner of the bend before or after the cooling gas is supplied to the conduit tube, the terminal, and the lead tube.

8. The bushing according to claim 1, wherein a radiating fin is provided on an outer surface of the inner corner of the bend of the terminal as the cooling means.

9. A generator comprising:
a generator main unit;
a containment vessel to place the generator main unit in a cooling gas atmosphere;
a bushing which penetrates the containment vessel and enables electric current to flow to the generator main unit; and
a blower and a gas cooler which feed cooling gas into the containment vessel and the bushing;
the bushing including
a conductive conduit tube;
a lead tube to be connected with the generator main unit; and
a tube type terminal which connects the conduit tube and the lead tube,
wherein the terminal has a bend and a cooling means for forced cooling of an inner corner of the bend of the terminal is provided.

10. The generator according to claim 9, wherein a guide is provided as the cooling means in the terminal to concentrate the cooling gas flowing through the terminal onto the inner corner of the bend.

11. The generator according to claim 10, wherein the guide is a guide vane which directs the cooling gas flowing through the terminal come closer to the inner corner.

12. The generator according to claim 11, wherein the guide vanes are provided on both upstream and downstream sides of the bend in a cooling gas flow direction and the upstream guide vane makes the cooling gas hit the upstream side of the inner corner and the downstream guide vane makes the cooling gas hit the downstream side of the inner corner.

13. The generator according to claim 9, wherein a radiating fin is provided on an inner surface of the inner corner of the bend of the terminal as the cooling means.

14. The generator according to claim 9,
wherein:
a part of the cooling gas supplied from the blower to the containment vessel is led into the conduit tube of the bushing and flows through the terminal and the lead tube into the gas cooler; and
a guide which directs the cooling gas supplied from the blower into the containment vessel so that the cooling gas hits an outer surface of the inner corner of the terminal is provided as the cooling means.

15. The generator according to claim 9, wherein a cooling gas guide cover directing the cooling gas, which is supplied into the containment vessel and flows toward an outer surface of the inner corner of the terminal of the bushing, into the bushing is provided in the containment vessel as the cooling means.

16. The generator according to claim 9,
wherein:
the cooling gas supplied from the blower flows in the bushing through the lead tube, the terminal and the conduit tube in the order of mention, and thereafter is discharged into the containment vessel; and
a guide directing the cooling gas, which is discharged through the bushing into the containment vessel, toward an outer surface of the inner corner of the terminal is provided as the cooling means.

17. The generator according to claim 9, wherein a radiating fin is provided on an outer surface of the inner corner of the bend of the terminal as the cooling means.
